(19) United States
(12) Patent Application Publication
(10) Pub. No.: US 2015/0059885 A1
(43) Pub. Date: Mar. 5, 2015

(54) VALVE ASSEMBLY

(71) Applicant: Caterpillar Global Mining Europe GmbH, Luenen, DE (US)

(72) Inventors: Christopher F. Gosling, Ibstock (GB); Tobias Lindenbaum, Munster (DE)

(73) Assignee: Caterpillar Global Mining Europe GmbH, Luenen (DE)

(21) Appl. No.: 14/018,662

(22) Filed: Sep. 5, 2013

(51) Int. Cl. F17C 13/06; F16K 15/02

(52) U.S. Cl. CPC F17C 13/06; F16K 15/025; F17C 2205/0388
USPC 137/543.17

(57) ABSTRACT

A valve is provided for a hydraulic tank. The valve includes a main body and an end cap. The main body includes a first section, a second section and a window. The first section has a solid configuration. The first section has a shoulder configured to contact with a spring. The second section extends from the first section. The second section has a hollow configuration. The window defined on a surface of the second section is positioned towards an end of the second section proximate to the first section. The window is configured to selectively receive a fluid flow from the hydraulic tank into the main body based on a position of the valve with respect to the hydraulic tank. The end cap has a hollow configuration. The end cap is coupled to another end of the second section of the main body.

### TECHNICAL FIELD

The present disclosure relates to a valve, and more specifically to the valve used in sealing of a hydraulic tank.

### BACKGROUND

A fluid tank associated with a machine is connected to a pump of the machine through a suction line. During servicing, such as, while replacing the pump or replacing an elastic coupling element of the pump, the pump needs to be disconnected from the fluid tank.

Generally, when the pump is disconnected from the fluid tank, the suction line is removed from the fluid tank, causing hydraulic fluid to spill out. The spilled hydraulic fluid may get contaminated and require replacement. This may also lead to contamination of the machine and environment.

W.O. Published Application Number 03/040575 relates to a hydraulic device with housing inside which is a space containing hydraulic fluid and an air volume. A breather assembly is further provided, having a breather duct extending between the outside atmosphere and the above-mentioned space, for aerating and de-aerating the above-mentioned space, in particular during the operation of the hydraulic device. The breather assembly is provided with shut-off means shut-off the breather duct until the hydraulic device is first put into operation. The hydraulic device is designed in such a way that when it is first put into operation the seal of the breather duct provided by the shut-off means is automatically and permanently removed.

### SUMMARY OF THE DISCLOSURE

In one aspect of the present disclosure, a valve is provided for a hydraulic tank. The valve includes a main body and an end cap. The main body includes a first section, a second section and a window. The first section has a solid configuration. The first section has a shoulder configured to contact with a spring. The second section extends from the first section. The second section has a hollow configuration. The window defined on a surface of the second section is positioned towards an end of the second section proximate to the first section. The window is configured to selectively receive a fluid flow from the hydraulic tank into the main body based on a position of the valve with respect to the hydraulic tank. The end cap has a hollow configuration. The end cap is coupled to another end of the second section of the main body.

In another aspect, a hydraulic tank is provided. The hydraulic tank includes an outlet port and a valve. The outlet port discharges a fluid flow from the tank. The valve is positioned at least partially within the outlet port. The valve includes a main body and an end cap. The main body includes a first section, a second section and a window. The first section has a solid configuration. The first section has a shoulder configured to contact with a spring. The second section extends from the first section. The second section has a hollow configuration. The window defined on a surface of the section is positioned towards an end of the second section proximate to the first section. The window is configured to selectively receive the fluid flow from the hydraulic tank into the main body based on a position of the valve with respect to the hydraulic tank. The end cap has a hollow configuration. The end cap is coupled to another end of the second section of the main body.

### BRIEF DESCRIPTION OF THE DRAWINGS

FIG. 1 is a perspective view of an exemplary shearer machine, according to one embodiment of the present disclosure;

FIG. 2 is a perspective view of a power pack of the machine having a hydraulic tank and a pump;

FIG. 3 is an exploded view of a valve;

FIG. 4 is a cross sectional view of the hydraulic tank, the valve and a pipe, the valve being in an open position;

FIG. 5 is a cutaway view of the valve when the valve is in the open position; and

FIG. 6 is a cutaway view of the valve when the valve is in a closed position.

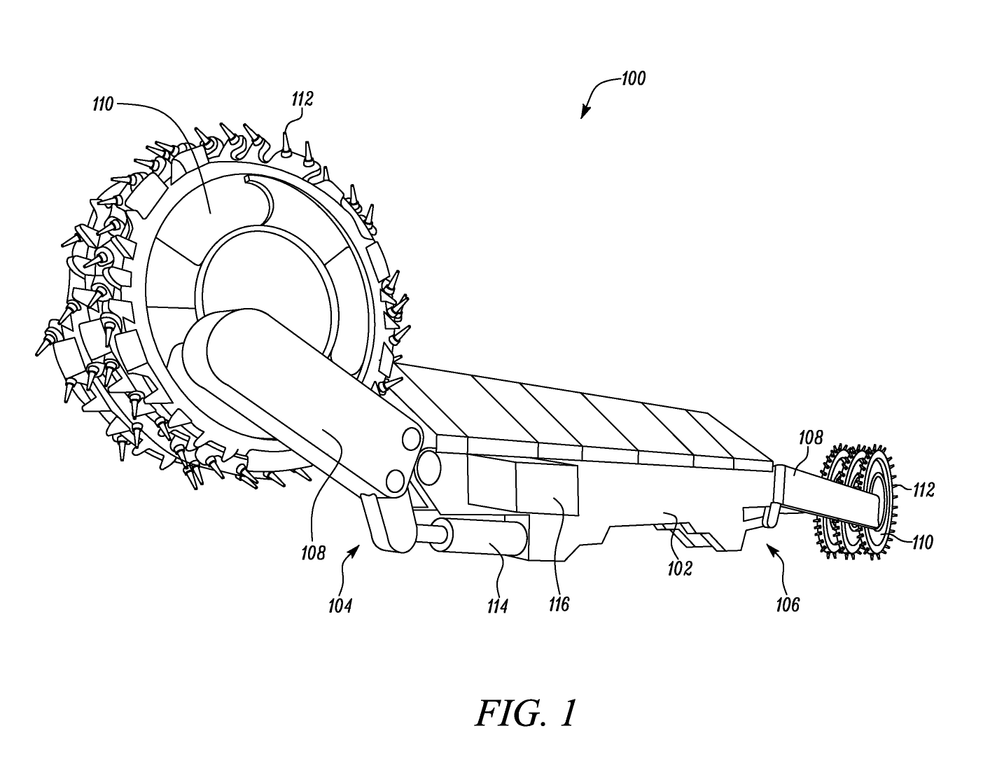

### DETAILED DESCRIPTION

Wherever possible, the same reference numbers will be used throughout the drawings to refer to the same or the like parts. Referring to FIG. 1, an exemplary mining machine 100 is illustrated. More specifically, the machine 100 is a shearer. The machine 100 is configured for shearing of coal from a coal face of a coal mine It should be noted that in addition to the coal, the machine 100 may be used for shearing of any other mineral from a face of a respective mine.

Alternatively, the machine 100 may embody any other machine such as, but not limited to, a large mining truck, an articulated truck, and an off-highway truck. Further, according to various embodiments, the machine 100 may be any other machine associated with industries such as mining, agriculture, construction, forestry, waste management, and material handling, among others.

As shown in FIG. 1, the machine 100 includes a main frame 102 having a first end 104 and a second end 106. The first end 104 includes an arm 108 pivotally coupled to the main frame 102. A cutter 110 is rotatably affixed to the arm 108. The cutter 110 includes blades 112 for the shearing of the coal from the coal face of the coal mine One or more hydraulic and/or pneumatic cylinders 114 are coupled to the main frame 102 and the arm 108. The hydraulic cylinders 114 facilitate in moving to the arm 108 and aligning the cutter 110 against the coal face of the coal mine A similar arrangement of the arm 108 and the cutter 110 may be provided on the second end 106 of the main frame 102 for the shearing of the coal. Configuration, size, dimension and location of the arm 108 and the cutter 110 provided on the second end 106 may be different from that provided on the first end 104 according to system design and requirements.

The machine 100 may include an armored face conveyor (not shown). The armored face conveyor may include a conveyor or a set of chains for haulage of the coal sheared from the coal face. The armored face conveyor may also include a track for mobility of the main frame 102 of the machine 100 within the coal mine. Further, the armored face conveyor may include a hydraulic system (not shown) for advancement of the machine 100 against the coal face for shearing of a required quantity of the coal from the coal face.

The machine 100 may include a roof support unit (not shown). The roof support unit may be configured for providing temporary support to a roof of the coal mine during the shearing operation. Further, the machine 100 may include a power source (not shown) for providing power for operation of the machine 100. The machine 100 may also include a drivetrain (not shown) coupled to the power source. The drivetrain may include any one or a combination of, but not limited to, gearing, differentials, drive shafts and hydraulic and/or pneumatic circuits including valves, lines, and distribution manifolds. The drivetrain may be configured to transmit power from the power source to the armored face conveyor, the cutter 110 and other operational components of the machine 100.

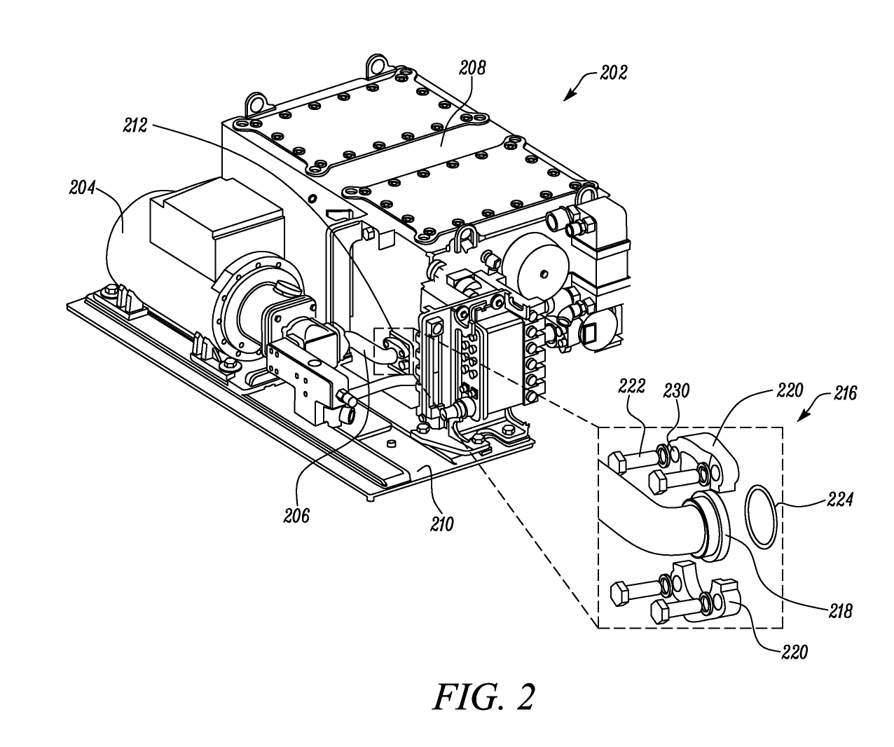

As shown in FIG. 1, an enclosure 116 is provided on the main frame 102 of the machine 100. The enclosure 116 houses a power pack 202 of the machine 100. The power pack 202 is provided for increasing a pressure of a fluid which is supplied to the hydraulic cylinders 114 associated with the machine 100. The fluid may be any known work fluid like, for example, oil. A perspective view of the power pack 202 is shown in FIG. 2. The power pack 202 may include various components, such as, but not limited to, a pump 204, a pipe 206 and a hydraulic tank 208. The hydraulic tank 208 may facilitate the storage of the fluid. Parameters related to the hydraulic tank 208, such as shape, dimensions, material used and so on may vary based on the application.

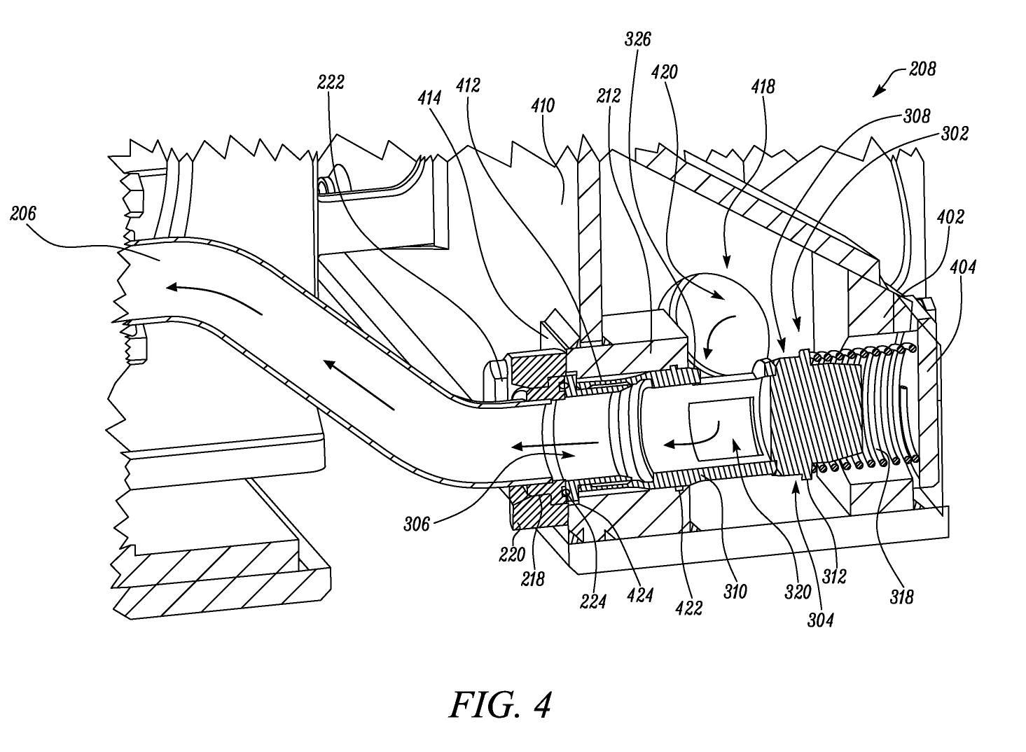

The pump 204 may be mounted on a base plate 210. In one embodiment, the pump 204 may be of a positive displacement type such as, but not limited to, a vane pump, a screw pump, and a diaphragm pump. In another embodiment, the pump 204 may be a rotodynamic type like a centrifugal pump or any other known design may be utilized. In one embodiment, the pump 204 may be selectively connected to the hydraulic tank 208 through the pipe 206. The pipe 206 is connected to the hydraulic tank 208 at an outlet port 212 (see FIG. 4) of the hydraulic tank 208, the outlet port 212 being located at a bottom portion of the hydraulic tank 208. The pipe 206 may be manufactured from a flexible material or any known metal.

An exploded view of a clamping arrangement 216 provided at one end of the pipe 206 is shown in FIG. 2. This end of the pipe 206 may be attached to the hydraulic tank 208 through the clamping arrangement 216. The clamping arrangement 216 may include a flange 218 provided at the given end of the pipe 206, a flange clamp 220, bolts 222 and a sealing ring 224. In one embodiment, the flange 218 may have a step like configuration at an outer surface and/or an inner surface of the flange 218. For example, the step provided on the outer surface may be utilized for securing the flange 218 to the flange clamp 220. The step provided on the inner surface of the flange 218 may be used for guiding the pipe 206 inside the flange 218. The flange 218 may be welded or brazed to the pipe 206. In one embodiment, as shown in the accompanying figures, the flange clamp 220 may have a two piece design. The two halves of the flange clamp 220 may surround the flange 218 of the pipe 206 when assembled. Each of the two halves includes holes 230 for receiving mechanical fasteners to attach the pipe 206 to the outlet port 212 of the hydraulic tank 208 for fluid communication between the hydraulic tank 208 and the pump 204. The sealing ring 224 may be used to seal the leakage of the fluid.

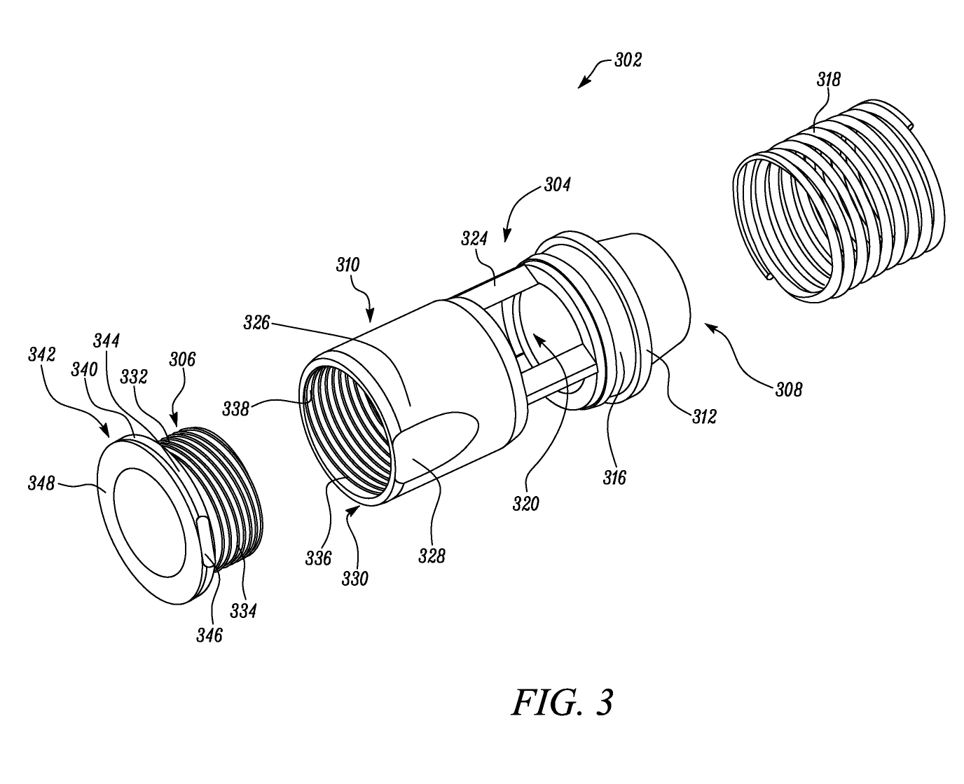

The present disclosure relates to a valve 302 associated with the hydraulic tank 208. The valve 302 is positioned within the outlet port 212 of the hydraulic tank 208. As shown in FIG. 3, the valve 302 includes a main body 304 and an end cap 306. The main body 304 and the end cap 306 may be manufactured from any metal known in the art. The main body 304 includes a first section 308 and a second section 310. The first section 308 of the main body 304 has a solid configuration. The first section 308 may define a shoulder 312 formed by a projection positioned circumferentially along an outer surface 316 of the first section 308. Further, one end of the first section 308 may have a tapered configuration to receive and contact with a spring 318. A spring force of the spring 318 may actuate the valve 302. The shoulder 312 may serve as an end stop for the spring 318 during operation of the valve 302. More particularly, during the operation of the valve 302, the spring force from the spring 318 may be transferred to the main body 304 through the shoulder 312 provided on the first section 308 of the valve 302.

The second section 310 has a hollow configuration. The second section 310 extends from the first section 308. A window 320 is defined on a surface of the second section 310 of the main body 304. The window 320 is positioned towards an end of the second section 310 which is extended from the first section 308 of the main body 304. The window 320 may selectively allow the fluid from the hydraulic tank 208 to enter into the main body 304 of the valve 302, based on a position of the window 320 within the outlet port 212 of the hydraulic tank 208. In one embodiment, a support structure 324 may be incorporated within the window 320 for rigidly attaching the first section 308 to the second section 310 of the main body 304. Opening and closing of the valve 302 will be described in detail in connection with FIGS. 4, 5 and 6. In one embodiment, an outer surface 326 of the second section 310 of the main body 304 may include flat portions 328 defined for holding and positioning the main body 304 during the assembly of the valve 302. These flat portions 328 are partially defined on the outer surface 326 of the second section 310 of the main body 304.

The end cap 306 may be received into an end 330 of the second section 310 distal from the end connecting the first and second sections 308, 310 of the main body 304. The end cap 306 has a hollow configuration. An outer surface 332 of the end cap 306 contains a plurality of threads 334 corresponding to a plurality of threads 336 provided on an inner surface 338 of the second section 310 of the main body 304. The plurality of threads 334, 336 may be of different types like, for example, triangular threads, square threads, trapezoidal threads, and buttress threads for allowing the coupling of the end cap 306 and the second section 310. The end cap 306 includes a flange 340 extending circumferentially from a distal end 342 of the end cap 306. An outer surface 344 of the flange 340 of the end cap 306 has a flat portion 346 defined for holding and positioning the end cap 306 during the assembly of the valve 302. An outer face 348 of the flange 340 may come in contact with the flange 218 of the pipe 206 when the pipe 206 is connected to the hydraulic tank 208. In one embodiment, a groove (not shown) may be provided on the outer face 348 of the flange 340 for receiving the sealing ring 224 positioned between the flange 218 of the pipe 206 and the flange 340 of the valve 302. The sealing ring 224 may prevent leakage of the fluid between the pipe 206 and the hydraulic tank 208.

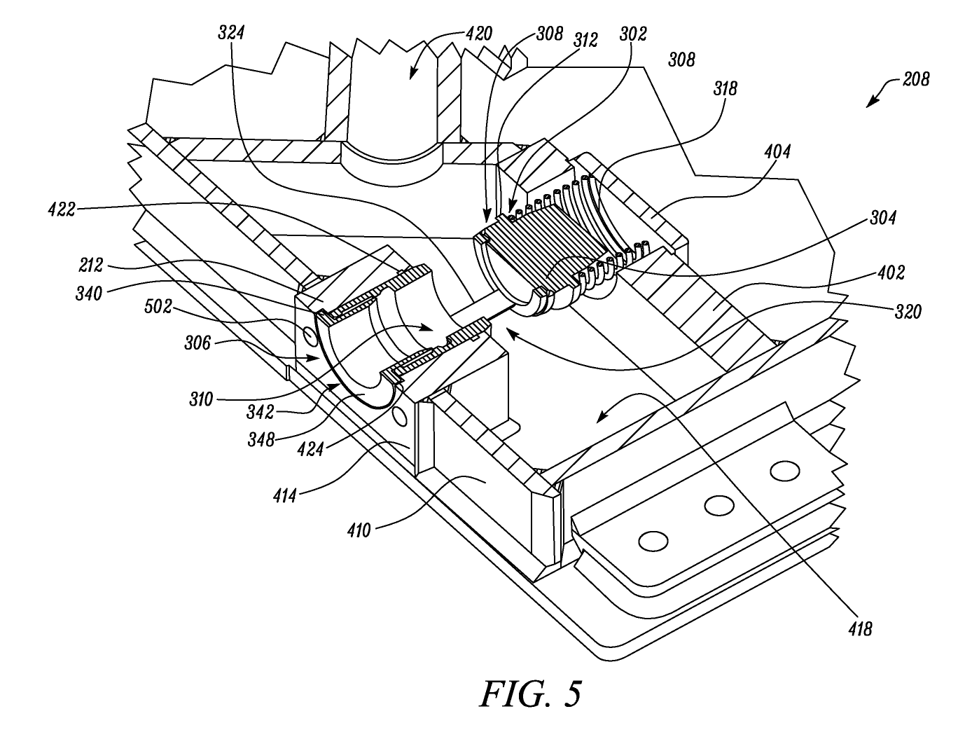

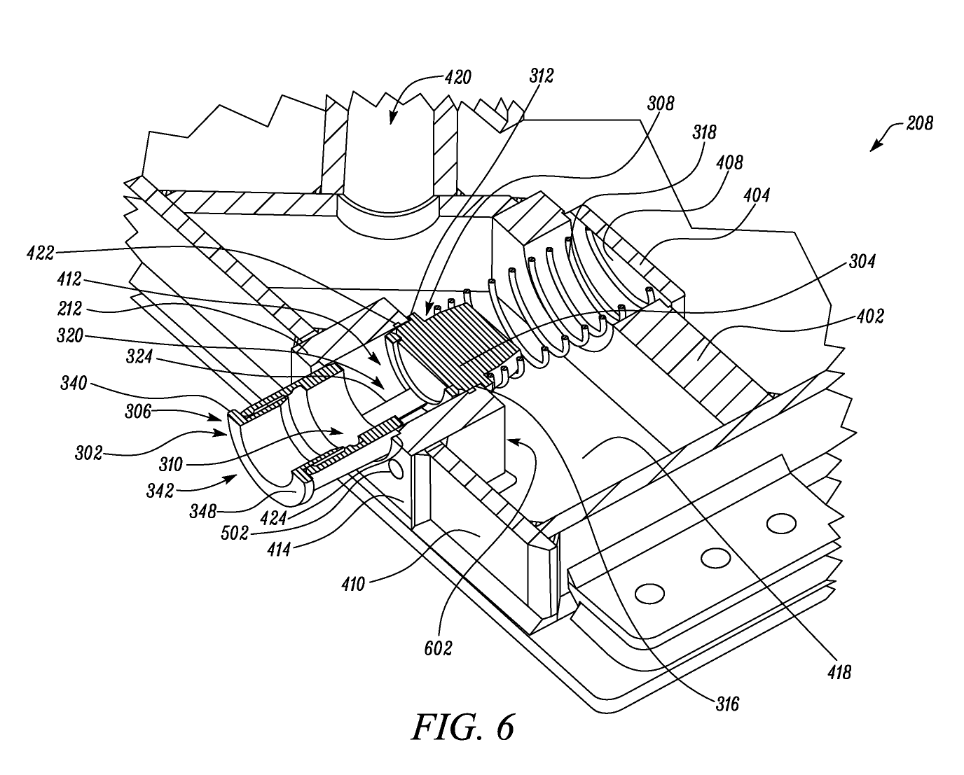

FIGS. 4 and 5 show the valve 302 in an open position. The valve 302 is in the open position when the pipe 206 is connected to the hydraulic tank 208 for drawing the fluid out of the hydraulic tank 208, through the valve 302 positioned within the outlet port 212 of the hydraulic tank 208 and into the pipe 206 by the suction effect of the pump 204. Arrows in FIG. 4 show a direction of the fluid flow. The pipe 206 is not shown in the cutaway section of FIG. 5 merely for the purpose of clarity. FIG. 6 shows the valve 302 in the closed position.

An internal wall 402 may be provided within the hydraulic tank 208 and a plate 404 is attached to a portion of the internal wall 402. The plate 404 may be attached to the internal wall 402 by using any known mechanical fasteners. The plate 404 is positioned behind the spring 318 of the valve 302 for providing a resting surface for the spring 318 to compress against when the valve 302 is in the open position. As shown in the accompanying figures, the outlet port 212 is situated on a side wall 410 of the hydraulic tank 208, such that a major portion of the outlet port 212 lies within the hydraulic tank 208. The outlet port 212 includes a channel 412 for receiving the valve 302 and guiding a movement of the valve 302 therein. An outer surface 414 of the outlet port 212 includes holes 502 (See FIG. 5) for receiving mechanical fasteners to connect the pipe 206 to the hydraulic tank 208.

As is clearly visible in FIGS. 4, 5, 6, an internal chamber 418 may be defined within the hydraulic tank 208 and surrounding the valve 302, the internal chamber 418 is configured to be flooded with the fluid flowing out through an aperture 420 provided within the hydraulic tank 208. The valve 302 is configured to selectively receive the fluid flow from the hydraulic tank 208 into the main body 304 based on the open position of the valve 302 with respect to the hydraulic tank 208 (as depicted in FIGS. 4 and 5). When the pipe 206 is attached to the outlet port 212, the flange clamp 220 may be bolted to the outlet port 212 of the hydraulic tank 208. The flange 218 of the pipe 206 drives the valve 302 into the internal chamber 418 enabling the valve 302 to be in the open position. When in the open position, the valve 302 is positioned partly within the outlet port 212 and partly within the internal chamber 418 of the hydraulic tank 208. The flange 218 of the end cap 306 rests in a step 424 provided in the outlet port 212 for holding the valve 302 within the outlet port 212.

The window 320 is positioned within the internal chamber 418 in such a manner that the fluid may be received into the second section 310. Referring to FIG. 4, the fluid flows from the second section 310 to the pump 204 through a passage created by the second section 310, the end cap 306 and the pipe 206. In the open position, the spring 318 may remain compressed against the plate 404 attached to the internal wall 402. In one embodiment, a sealing ring 422 may be provided between the outer surface 326 of the valve 302 and the outlet port 212 to prevent leakage of the fluid.

Referring now to FIG. 6, the closed position of the valve 302 will be explained. The valve 302 is configured to disconnect the fluid flow from the hydraulic tank 208 into the main body 304 when the pipe 206 is disconnected from the valve 302. More particularly, when the flange clamp 220 is removed from the outlet port 212, the spring 318 may exert the spring force on the shoulder 312 of the first section 308 of the main body 304 of the valve 302, causing the valve 302 to move in an outward direction with respect to the side wall 410 of the hydraulic tank 208. When in the closed position, the valve 302 is positioned partially within the hydraulic tank 208 and partially outside of the hydraulic tank 208. The window 320 is positioned within and covered by the outlet port 212 such that the fluid flow is prevented from entering into the second section 310. This allows for sealing of the hydraulic tank 208 on disconnection of the pipe 206. The shoulder 312 provided in the first section 308 of the valve 302 may come in contact with an inner wall 602 of the outlet port 212 thereby restricting the outward movement of the valve 302 within the outlet port 212 of the hydraulic tank 208. The sealing ring 422 provided between the outer surface 316 of the first section 308 of the valve 302 and the channel 412 of the outlet port 212 may prevent the leakage of the fluid when the valve 302 is in the closed position.

### INDUSTRIAL APPLICABILITY

Known hydraulic tank designs may leak when the pipe is disconnected from the hydraulic tank during servicing. The valve 302 provided in the present disclosure is configured to automatically seal the hydraulic tank 208 when the pipe 206 is disconnected from the hydraulic tank 208. This may prevent the hydraulic fluid from spilling out of the hydraulic tank 208. The valve 302 may provide a simplistic and cost effective solution. A person of ordinary skill in the art will appreciate that the valve 302 disclosed herein may be utilized in connection with a tank present on any machine 100 and is not limited to the application disclosed herein.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A valve for a hydraulic tank, the valve comprising:
a main body comprising:
a first section having a solid configuration, the first section having a shoulder configured to contact with a spring;
a second section extending from the first section, the second section having a hollow configuration; and
a window defined on a surface of the second section, the window being positioned towards an end of the second section proximate to the first section, wherein the window is configured to selectively receive a fluid flow from the hydraulic tank into the main body based on a position of the valve with respect to the hydraulic tank; and
an end cap having a hollow configuration, wherein the end cap is coupled to another end of the second section of the main body.

2. The valve of claim 1, wherein the end cap comprises a plurality of threads provided on an outer surface of the end cap corresponding to threads provided on an inner surface of the another end of the second section to couple the end cap to the second section.

3. The valve of claim 1, wherein the end cap further comprises a flange extending from a distal end of the end cap.

4. The valve of claim 3, wherein an outer face of the flange is configured to be coupled to a pipe, the pipe configured to draw the fluid flow from the hydraulic tank through the valve, based on a connection of the pipe with the valve.

5. The valve of claim 4, wherein the outer face of the flange further comprises a sealing ring provided to seal the pipe with the valve.

6. The valve of claim 1, wherein the valve is configured to be at least partially positioned within an outlet port of the hydraulic tank.

7. The valve of claim 6, wherein the valve is configured to move to any one of:
an open position such that the window of the second section is configured to receive the fluid flow from the hydraulic tank and the outlet port is fluidly connected to a pipe; and
a closed position such that the window of the second section is covered by the outlet port for disconnecting the outlet port from the pipe,
wherein the movement of the valve is actuated by a spring force associated with the spring.

8. The valve of claim 7 further comprising a sealing ring provided around an outer surface of the second section of the main body for preventing the fluid flow from leaking into the outlet port when the valve is in the open position.

9. A hydraulic tank comprising:
an outlet port for discharging a fluid flow from the hydraulic tank; and
a valve positioned at least partially within the outlet port, the valve comprising:
a main body comprising:
a first section having a solid configuration, the first section having a shoulder configured to contact with a spring;
a second section extending from the first section, the second section having a hollow configuration; and
a window defined on a surface of the second section, the window being positioned towards an end of the second section proximate to the first section, wherein the window is configured to selectively receive the fluid flow from the hydraulic tank into the main body based on a position of the valve with respect to the hydraulic tank; and
an end cap having a hollow configuration, wherein the end cap is coupled to another end of the second section of the main body.

10. The hydraulic tank of claim 9, wherein the hydraulic tank is present on a machine.

11. The hydraulic tank of claim 9, wherein the end cap comprises a plurality of threads provided on an outer surface of the end cap corresponding to threads provided on an inner surface of the another end of the second section to couple the end cap to the second section.

12. The hydraulic tank of claim 9, wherein the outlet port of the hydraulic tank is fluidly connected to a pump via a pipe.

13. The hydraulic tank of claim 12, wherein the end cap of the valve further comprises a flange extending from a distal end of the end cap.

14. The hydraulic tank of claim 13, wherein an outer face of the flange is configured to be coupled to the pipe, the pipe configured to draw the fluid flow from the hydraulic tank through the valve, based on a connection of the pipe with the valve.

15. The hydraulic tank of claim 14, wherein the outer face of the flange further comprises a sealing ring provided to seal the pipe with the valve.

16. The hydraulic tank of claim 9, wherein the valve is configured to move to any one of:
an open position such that the window of the second section is configured to receive the fluid flow from the hydraulic tank and the outlet port is fluidly connected to the pipe; and
a closed position such that the window of the second section is covered by the outlet port for disconnecting the outlet port from the pipe,
wherein the movement of the valve is actuated by a spring force associated with the spring.

17. The hydraulic tank of claim 16 further comprising a sealing ring provided around an outer surface of the second section of the main body for preventing the fluid flow from leaking into the outlet port when the valve is in the open position.
